(19) United States
(12) Patent Application Publication
(10) Pub. No.: US 2008/0288341 A1
(43) Pub. Date: Nov. 20, 2008

(54) AUTHORED-IN ADVERTISEMENTS FOR DOCUMENTS

(76) Inventors: Kurt Garbe, Saratoga, CA (US); Tom Muller, Pleasanton, CA (US); Ken Feuerman, Fremont, CA (US); Viraj Chatterjee, Delhi (IN); Damanjit Singh, New Delhi (IN); Neha Bhayana, Noida (IN)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 11/748,242

(22) Filed: May 14, 2007

(51) Int. Cl. G06Q 30/00

(52) U.S. Cl. 705/14

(57) ABSTRACT

A method, apparatus and computer program product for associating advertisements with a document is presented. A document for having advertisements associated therewith is identified, the document comprising a portable electronic document. At least one advertisement tag is provided for the document, the advertisement tag identifying possible types of advertising materials appropriate for the document. A document ID is also provided for associating an advertisement with the electronic document. When the document is viewed the at least one advertisement tag associated with the electronic document is sent to an advertisement partner. At least one advertisement is received from the advertisement partner and the at least one advertisement is rendered with the document.

### BACKGROUND

Conventional technologies for presenting advertisements to potential customers provide a variety of mediums in which to present those advertisements. For example, advertisements can be displayed electronically on web sites or via search engines. Advertisements can also be displayed on web sites, for example, via an advertisement banner. Additionally, advertisements can be displayed on search engines via a sponsored advertisement. Advertisers pay for the advertisements by choosing keywords or keyword phrases, and competing against other advertisers who also want their advertisements to appear on web sites relevant to those keywords or keyword phrases.

When an end user enters a web site containing advertisements, the advertisements (for which the advertisers have bid on keyword or keyword phrases) are displayed. The displaying of the advertisements is referred to as an ‘impression’. The advertisers do not pay for impressions. However, when an end user selects (i.e., “clicks”) on an advertisement, the advertiser is charged for that selection. The advertiser is charged whatever amount the advertiser bid on the keyword or keyword phrase that caused the displaying (i.e., impression) of the advertisement. Each time an end user clicks on the advertisement, the advertiser is charged for that selection. This is known as “pay per click” since the advertiser only pays for the advertisement when an end user selects (i.e., “clicks”) on the advertisement. In some environments, web site owners also receive an amount of revenue each time an end user selects (i.e., “clicks”) on an advertisement that appears on the web site owner's web site.

Conventional computerized devices, such as personal computers, laptop computers, and the like utilize graphical user interfaces in applications such as operating systems and graphical editors (i.e., web page editors, document editors, video editors, etc.) that enable users to quickly provide input and create projects. In general, using a graphical user interface, a user operates an input device such as a mouse or keyboard to manipulate digital content on a computer display. The digital content is often represented as icons, and the user can operate an input device such as a mouse to move a mouse pointer onto an icon (i.e., graphically overlapping the icon on the graphical user interface). By depressing a mouse button, the application (such as the operating system desktop) selects the icon, and if the user maintains the mouse button in a depressed state, the user can drag the icon across the graphical user interface. By releasing the mouse button, the icon is placed on the graphical user interface at the current position of the mouse pointer. Using graphical user interface technology, users can create projects by dragging and dropping digital content (i.e., graphical objects, text, text boxes, images, videos, etc) into the project.

A “portable electronic document” is a collection of data which includes objects which have been stored in a portable electronic document language. The document is organized and stored in a “document file”, which can be a storage unit such as a file, data structure, or the like. Portable electronic documents can be stored in a variety of different languages and formats. In one embodiment, the portable electronic document is described with reference to the Portable Document Format (PDF) by Adobe Systems, Inc. of San Jose, Calif., or similar types of formats. PDF is a “page-based” format, in that a document includes a number of pages and is typically presented to a user on a page-by-page basis, i.e., the user typically views one page (or a portion of a page) at a time on a display screen. Other page-based document formats with similar document structures can also be adapted for use with the present invention.

People can place advertisements in their portable electronic documents presently by selling space within the document, similar to how a magazine publisher would sell advertisement space in their magazine. A document comprising portable electronic is a document that can be viewed without using a web browser. These portable electronic documents include, but are not limited to documents created with a word processor application, a spreadsheet, a presentation created using a software application such as PowerPoint, a Portable Document Format (PDF) document or the like.

### SUMMARY

Conventional mechanisms such as those explained above suffer from a variety of deficiencies. One such deficiency is that conventional advertisement mechanisms such as Adsense (available from Google) deals strictly with website content and places advertisements via dynamic advertisement insertion within the rendered web page. Adsense does not deal with portable electronic documents such as PDF documents, files created using a word processing application such as Microsoft Word or WordPerfect, files comprising slides created using Microsoft PowerPoint, files comprising drawings created by Visio or Micrografx, or the like. A document comprising a portable electronic document is a document that can be viewed without using a web browser.

In portable electronic documents today, in order to sell advertisements requires considerable effort similar to what a magazine publisher would do. The author of the portable electronic document (e.g., a PDF file) would need to identify potential advertisement sponsors. The author would also need to design how much space the portable electronic would have available for advertisement space. Next, the author would have to develop a business model for selling the advertisement space (e.g. identify the circulation numbers, target demographics, advertising rates, and the like). Further, if required for the business model or the potential advertisement sponsors, the author would have to conduct analysis of the reach and effectiveness of the market that the portable electronic document reaches. The author would also be required to sell the advertisement space to the advertisement sponsors and insert the sponsor advertisements into the portable electronic document.

The above process is costly (e.g. requiring potential market research, a sales team for the advertisements, etc.) is static and is not responsive to changes in the market. Once an advertisement is inserted into a portable electronic document, the advertisement is there for good. As an example, if the advertisement sponsor goes out of business, the portable electronic document author can only re-sell that advertisement space by creating a new portable electronic document however, the old portable electronic document is still out in the market. As another example, if an author has created a compelling portable electronic document on a topic area, they may find that over time, more and more people would want to have an advertisement in that portable electronic document and as such, the author could receive a higher rate for that same portable electronic document over time. Further, the cost of proving in the value of the advertisement and tracking results is very high and can only reasonably be accomplished through sampling. This requires considerable effort, especially for portable electronic document publishers who would view advertisements as a side benefit to publishing their content versus their entire business model.

Embodiments of the invention significantly overcome such deficiencies and provide mechanisms and techniques that provide the ability for authors of portable electronic documents to include dynamic, contextual advertisements with their document. The author receives payment based on how often the advertisement is clicked through. The advertisements could show up either within the portable electronic document itself or as a side pane in the document viewing experience.

In a particular embodiment of a method for including advertisements with a document, the method includes identifying a document for having advertisements associated therewith, the document comprising a portable electronic document. The method further includes providing at least one advertisement tag for the document, the advertisement tag identifying possible types of advertising materials appropriate for the document. Additionally the method includes providing a document identifier (ID) for associating an advertisement with the document.

In another particular embodiment, a method of rendering a portable electronic document having advertisements associated therewith is described. The method includes identifying that the document has advertisements associated therewith and sending at least one advertisement tag associated with the document to an advertisement partner. The method further includes receiving at least one advertisement from the advertisement partner in response to the sending at least one advertisement tag associated with the document. Additionally the method includes rendering the at least one advertisement with the document.

Other embodiments include a computer readable medium having computer readable code thereon for associating advertisements with a document. The computer readable medium, in a particular embodiment, includes instructions for identifying a document for having advertisements associated therewith, the document comprising a portable electronic document. The computer readable medium further includes instructions for providing at least one advertisement tag for the document, the advertisement tag identifying possible types of advertising materials appropriate for the document, and instructions for providing a document ID for associating an advertisement with the document.

Other embodiments include a computer readable medium having computer readable code thereon for rendering a portable electronic document having advertisements associated therewith. In a particular embodiment, the computer readable medium includes instructions for identifying that the document has advertisements associated therewith. The computer readable medium also includes instructions for sending at least one advertisement tag associated with the document to an advertisement partner and instructions for receiving at least one advertisement from the advertisement partner in response to the sending at least one advertisement tag associated with the document. The computer readable medium further includes instructions for rendering the at least one advertisement with the document.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides authored-in advertisements for portable electronic documents as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing authored-in advertisements for portable electronic documents as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Adobe Systems, Incorporated of San Jose, Calif.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates an example computer system architecture for a computer system that performs associating advertisements with a document and rendering a document having advertisements associated therewith in accordance with embodiments of the invention;

FIG. 2 depicts a screenshot showing a document wherein the document has had a location for an advertisement insertion selected in accordance with embodiments of the invention;

FIG. 3 depicts a screenshot showing a document wherein the document has had an advertisement selected in accordance with embodiments of the invention;

FIG. 4 depicts a screenshot showing a document wherein the document has had an advertisement inserted therein in accordance with embodiments of the invention;

FIG. 5 depicts a flow diagram of a particular embodiment of a method of for associating advertisements with a document in accordance with embodiments of the invention;

FIG. 6 depicts a flow diagram of a particular embodiment of a method of identifying a document is capable of having advertisements associated therewith in accordance with embodiments of the invention;

FIG. 7 depicts a flow diagram of a particular embodiment of a method of rendering a document having advertisements associated therewith in accordance with embodiments of the invention; and

FIG. 8 depicts a flow diagram of a particular embodiment of a method of rendering a document having advertisements associated therewith and for tracking revenue associated with the advertisement in accordance with embodiments of the invention.

### DETAILED DESCRIPTION

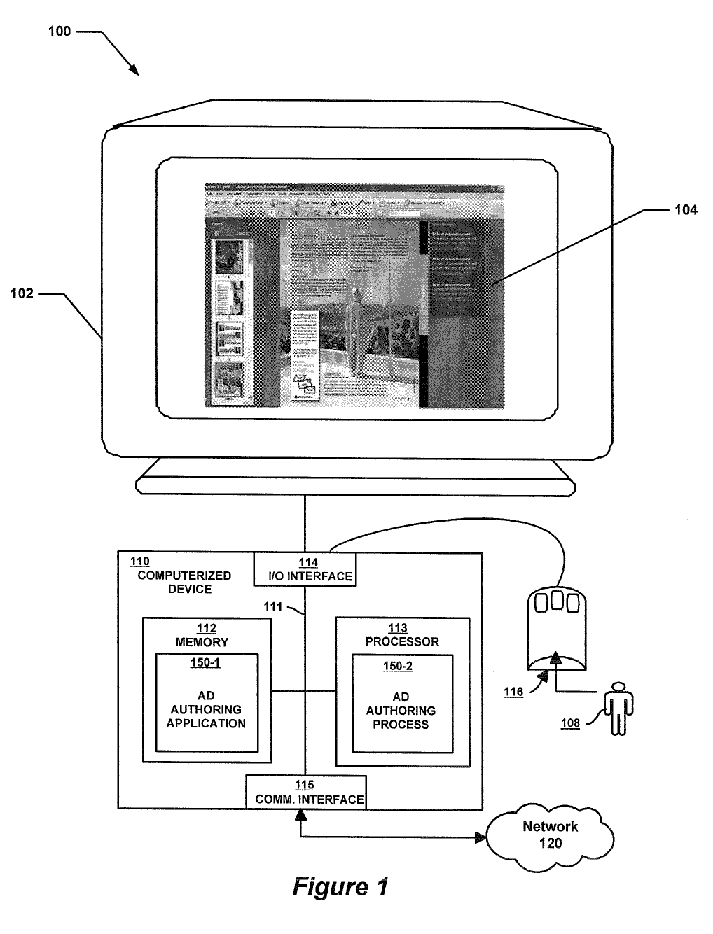

FIG. 1 depicts a block diagram illustrating an example architecture 100 of a computer system 110 that executes, runs, interprets, operates or otherwise performs an advertisement authoring application 540-1 and an advertisement authoring process 150-2 suitable for use in explaining example configurations disclosed herein. The computer system 110 may be any type of computerized device such as a personal computer, workstation, portable computing device, console, laptop, network terminal or the like. An input device 116 (e.g., one or more user/developer controlled devices such as a keyboard, mouse, etc.) couples to processor 113 through I/O interface 114, and enables a user 108 to provide input commands, and generally control the graphical user interface 160 that the an advertisement authoring application 150-1 and an advertisement authoring process 150-2 provides on the display 102. As shown in this example, the computer system 110 includes an interconnection mechanism 111 such as a data bus or other circuitry that couples a memory system 112, a processor 113, an input/output interface 114, and a communications interface 115. The communications interface 115 enables the computer system 110 to communicate with other devices (i.e., other computers) on a network 120.

The memory system 112 is any type of computer readable medium, and in this example, is encoded with an advertisement authoring application 150-1 as explained herein. The advertisement authoring application 150-1 may be embodied as software code such as data and/or logic instructions (e.g., code stored in the memory or on another computer readable medium such as a removable disk) that supports processing functionality according to different embodiments described herein. During operation of the computer system 110, the processor 113 accesses the memory system 112 via the interconnect 111 in order to launch, run, execute, interpret or otherwise perform the logic instructions of the user selected advertising application 140-1. Execution of the advertisement authoring application 140-1 in this manner produces processing functionality in an advertisement authoring process 150-2. In other words, the advertisement authoring process 150-2 represents one or more portions or runtime instances of the advertisement authoring application 150-1 (or the entire advertisement authoring application 150-1) performing or executing within or upon the processor 113 in the computerized device 110 at runtime.

It is noted that example configurations disclosed herein include the advertisement authoring application 150-1 itself (i.e., in the form of un-executed or non-performing logic instructions and/or data). The advertisement authoring application 150-1 may be stored on a computer readable medium (such as a floppy disk), hard disk, electronic, magnetic, optical, or other computer readable medium. The advertisement authoring application 150-1 may also be stored in a memory system 112 such as in firmware, read only memory (ROM), or, as in this example, as executable code in, for example, Random Access Memory (RAM). In addition to these embodiments, it should also be noted that other embodiments herein include the execution of the advertisement authoring application 150-1 in the processor 113 as the advertisement authoring process 150-2. Those skilled in the art will understand that the computer system 110 may include other processes and/or software and hardware components, such as an operating system not shown in this example.

A display 102 need not be coupled directly to computer system 110. For example, the advertisement authoring application 150-1 can be executed on a remotely accessible computerized device via the network interface 115. In this instance, the graphical user interface 104 may be displayed locally to a user 108 of the remote computer, and execution of the processing herein may be client-server based.

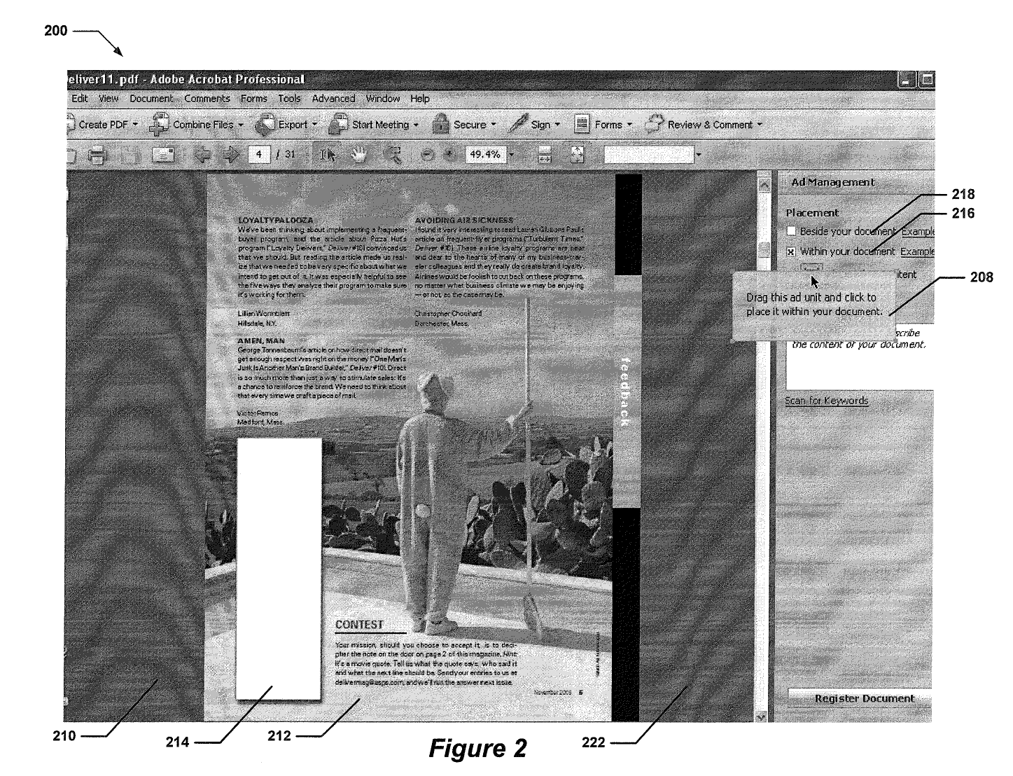

Referring now to FIG. 2, an example screen shot of a graphical user interface (GUI) 200 is shown. A portable electronic document 212 (e.g., a PDF document) has been rendered within the GUI 200. In this example, the document 212 includes a person dressed in a bunny suit, holding a butterfly net, standing in front of a cactus. Also shown are a left side pane 210 and a right side pane 222, with the document 212 centered between the side panes 210 and 222. The author (or other party, for purposes of this discussion also considered an author) of the document has decided to include an advertisement with this document.

GUI 200 also shows an option wherein the author can determine where to place the advertisement. For example, in this embodiment, the author has selected to place the advertisement within the document by clicking box 216. The author has clicked on box 208 and has dragged the advertisement unit into document 212 and placed the advertisement at location 214. The advertisement will be placed within the document 212 at location 214 which represents the advertisement placement area. Alternately, the author could have selected box 218 and had the advertisement placed beside the document, e.g., in left side pane 210 or in right side pane 222.

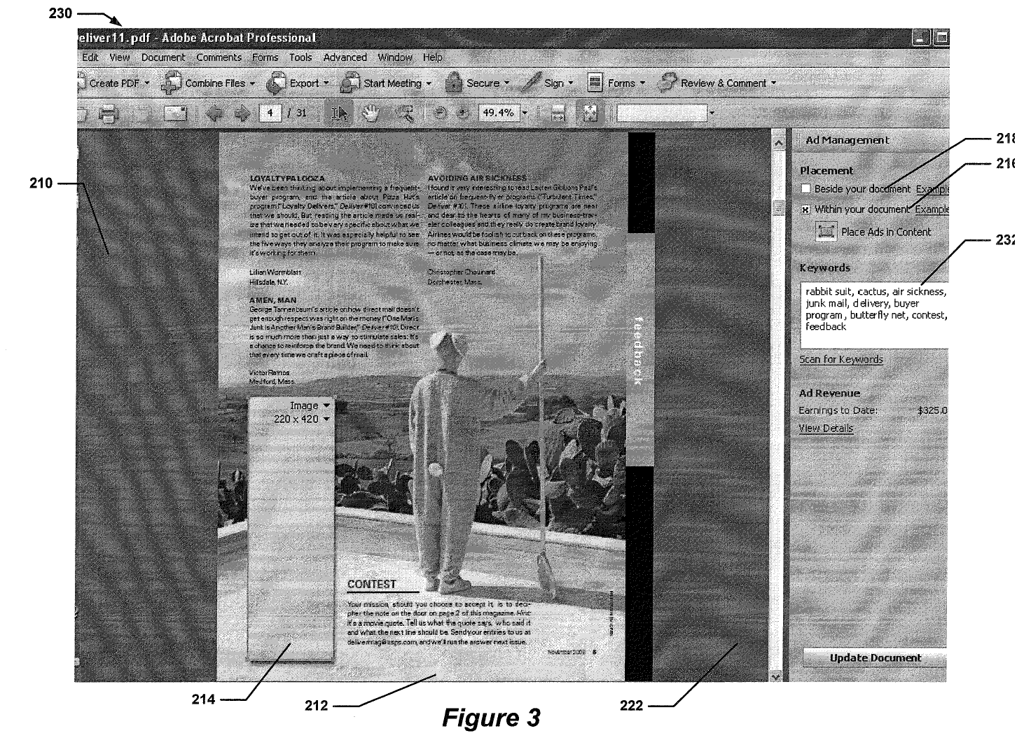

Referring now to FIG. 3, a GUI 230 is shown. The advertisement includes several properties. The advertisement is referred to as a contextual advertisement, in that the advertisement that is placed is based on the context of the document being viewed. In this example, certain keywords 232 are associated with the document, and are used to help determine a proper advertisement that is somewhat related to the subject matter of the document. The keywords may have entered by the document author. For example, an advertisement for car rental if the document being viewed is a travel brochure. The advertisements may also be dynamic advertisements in that on each viewing of the portable electronic document 212, the advertisement that shows up may change. This change may based on the advertisement inventory and additional viewing factors, e.g., time of day, time of year, geography in which the document is opened (for example, a snowboarding advertisement would show up in the winter, and a tennis advertisement in the spring). Also displayed in GUI 230 is advertisement placement area 214, which shows that the advertisement will be an image and the size of the image.

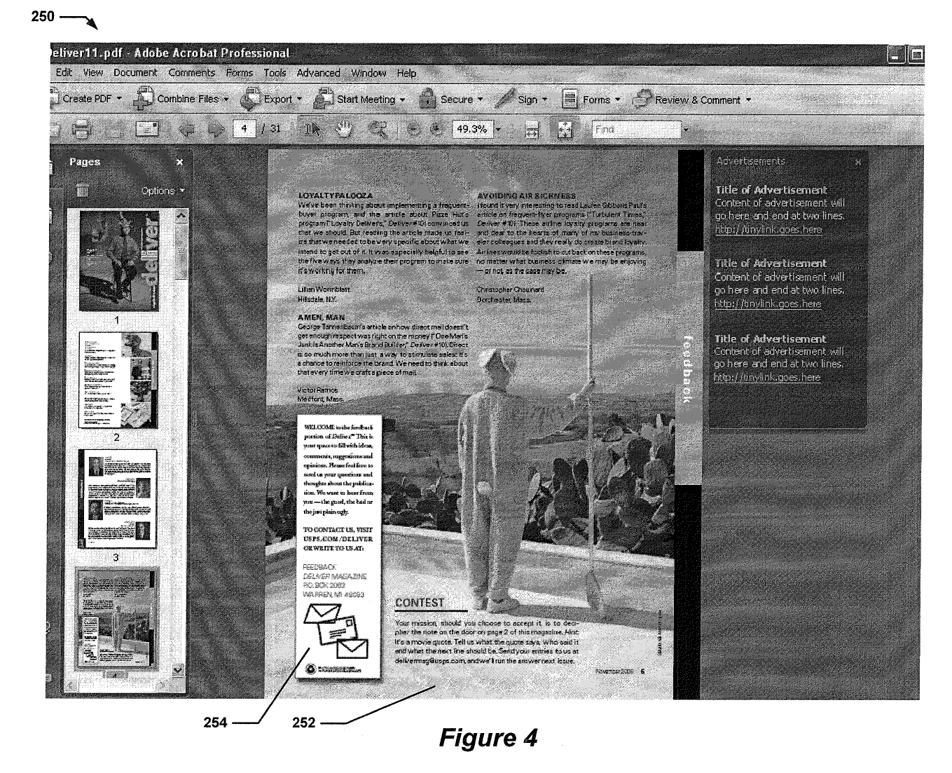

FIG. 4 shows a screen shot 250 of the portable electronic document 252 having an advertisement 254 inserted therein. Should a viewer of the document select (i.e., “click”) on the advertisement 254, the advertiser is charged for that selection. The advertiser is charged whatever amount the advertiser bid on the keyword or keyword phrase that caused the displaying (i.e., impression) of the advertisement. Each time a viewer clicks on the advertisement, the advertiser is charged for that selection. In some environments, web site owners may also receive an amount of revenue each time a viewer selects (i.e., clicks on) the advertisement 254 that appears with the document.

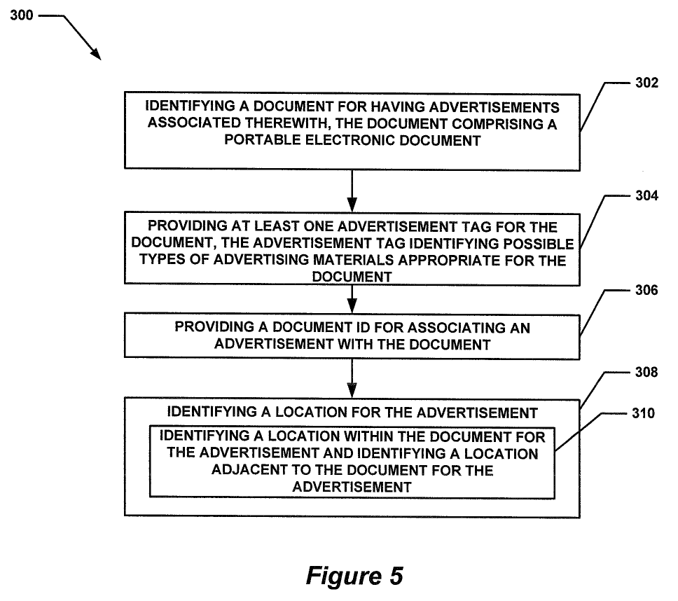

Flow charts of particular embodiments of the presently disclosed methods are depicted in FIG. 5 through FIG. 8. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring to FIG. 5, a flow diagram of a particular embodiment of a method 300 for associating advertisements with a document is shown. The method 300 begins with processing block 302, which recites identifying a document for having advertisements associated therewith, the document comprising a portable electronic document. The author of the document has selected an option setting (e.g., a metadata field or a tag) such that the document will have advertisements associated therewith. A document comprising portable electronic is a document that can be viewed without using a web browser. These portable electronic documents include, but are not limited to documents created with a word processor application, a spreadsheet, or a presentation created using a software application such as PowerPoint or the like. In a particular embodiment, the document is a PDF document.

Processing block 304 recites providing at least one advertisement tag for the document, the advertisement tag identifying possible types of advertising materials appropriate for the document. In some embodiments the advertisement is referred to as a contextual advertisement, in that the advertisement that is placed is based on the context of the document being viewed. Certain keywords are associated with the document, and are used to help determine a proper advertisement that is somewhat related to the keywords. For example, a proper advertisement to display might be for car rentals if the document being viewed is a travel brochure. In other embodiments, the advertisements may also be dynamic advertisements in that on each viewing of the portable electronic document, the advertisement that shows up may change. This change may be based on the advertisement inventory and additional viewing factors, e.g., time of day, time of year, geography in which the document is opened (for example, a snowboarding advertisement would show up in the winter, and a tennis advertisement in the spring).

Processing continues with processing block 306, which discloses providing a document identifier (ID). The document ID is used for associating an advertisement with the document.

Processing block 308 states identifying a location for the advertisement. As further recited in processing block 310, the location for the advertisement comprises one of the group consisting of identifying a location within the document for the advertisement, and identifying a location adjacent to the document for the advertisement (e.g., a left side pane or a right side pane).

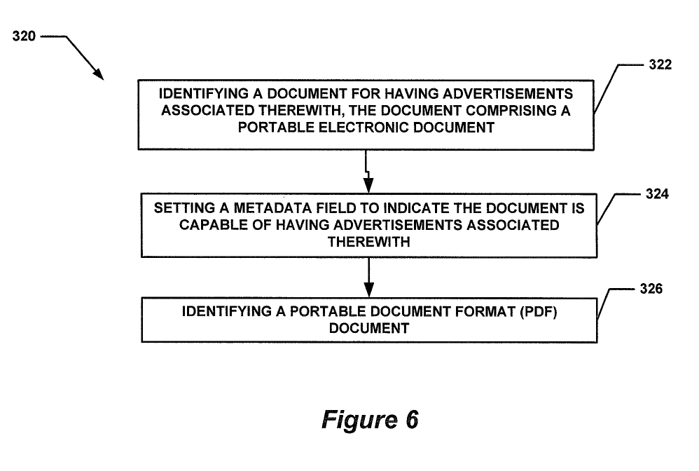

Referring now to FIG. 6, a flow diagram of a particular embodiment of a method 320 of identifying a document is capable of having advertisements associated therewith is shown. The method 320 begins with processing block 322, which recites identifying a document for having advertisements associated therewith, the document comprising a portable electronic document. A portable electronic document is a collection of data which includes objects which have been stored in a portable electronic document language. The document is organized and stored in a “document file”, which can be a storage unit such as a file, data structure, or the like. Portable electronic documents can be stored in a variety of different languages and formats. In one embodiment, the portable electronic document is described with reference to the Portable Document Format (PDF) by Adobe Systems, Inc. of San Jose, Calif., or similar types of formats. PDF is a “page-based” format, in that a document includes a number of pages and is typically presented to a user on a page-by-page basis, i.e., the user typically views one page (or a portion of a page) at a time on a display screen. Other page-based document formats with similar document structures can also be adapted for use with the present invention.

Processing block 324 discloses setting a metadata field to indicate the document is capable of having advertisements associated therewith. In a particular embodiment the meta data may include dimensions of advertisements that can be accommodated. Processing block 326 states identifying a document for having advertisements associated therewith comprises identifying a Portable Document Format (PDF) document.

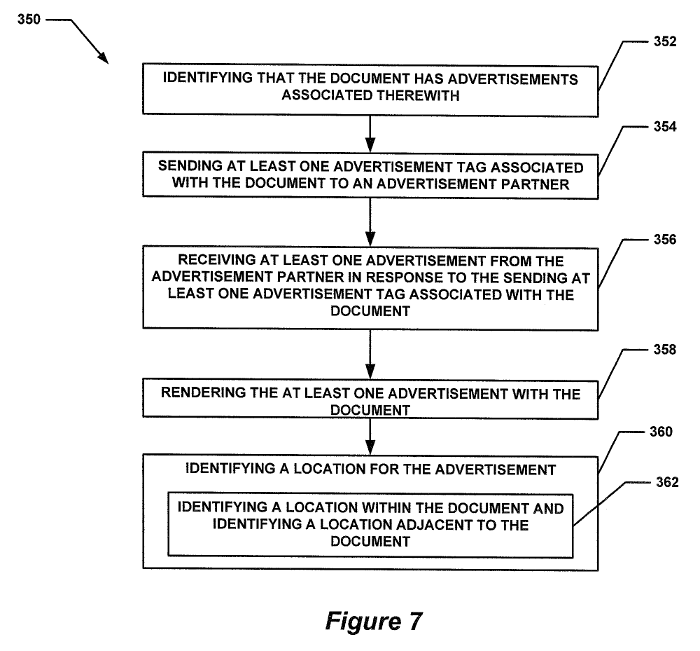

Referring now to FIG. 7, a particular embodiment of a method 350 of rendering a portable electronic document having advertisements associated therewith is shown. The method 350 begins with processing block 352, which discloses identifying that the portable electronic document has advertisements associated therewith. This has been determined by the author of the portable electronic document having set a field or tag in order to allow advertisement to be associated with the portable electronic document.

Processing block 354 states sending at least one advertisement tag associated with the document to an advertisement partner. This advertisement tag is used to identify the type of content the document is disclosing such that advertisements relating to the type of content can be rendered with the document. For example, a proper advertisement to display might be for car rentals if the document being viewed is a travel brochure.

Processing continues with processing block 356 which recites receiving at least one advertisement from the advertisement partner in response to the sending at least one advertisement tag associated with the document. The advertisement may be a contextual advertisement, in that the advertisement that is placed is based on the context of the document being viewed. Certain keywords are associated with the document, and are used to help determine a proper advertisement that is somewhat related to the keywords. For example, a proper advertisement to display might be for car rentals if the document being viewed is a travel brochure. The advertisements may also be dynamic advertisements in that on each viewing of the portable electronic document, the advertisement that shows up may change. This change may based on the advertisement inventory and additional viewing factors, e.g., time of day, time of year, geography in which the document is opened (example, a snowboarding advertisement would show up in the winter, a tennis advertisement in the spring). Processing block 358 discloses rendering the at least one advertisement with the document. In a particular embodiment, once an advertisement is downloaded from the partner, the advertisement is stored with the document, so that if there is viewing of the document offline, the last advertisement downloaded is still presented to the viewer of the document.

The method may further include processing block 360, which states identifying a location for the advertisement. As shown in processing block 362, this may include rendering the advertisement within the document or rendering the advertisement adjacent to the document (e.g., in a side pane).

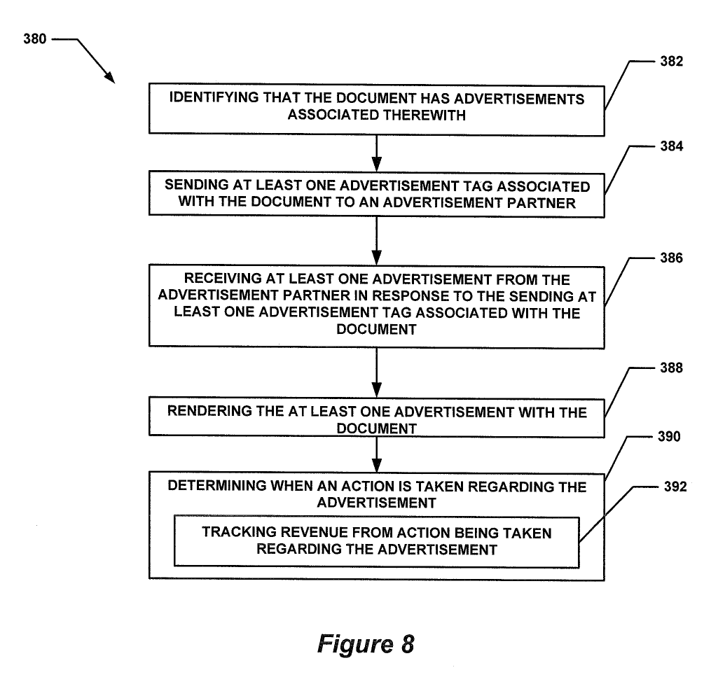

Referring now to FIG. 8, a particular embodiment of a method 380 of rendering a document having advertisements associated therewith and for tracking revenue associated with the advertisement is shown. The method 380 begins with processing block 382, which discloses identifying that the portable electronic document has advertisements associated therewith. This has been determined by the author of the portable electronic document having set a field or tag in order to allow advertisement to be associated with the portable electronic document.

Processing block 384 states sending at least one advertisement tag associated with the document to an advertisement partner. This advertisement tag is used to identify the type of content the document is disclosing such that advertisements relating to the type of content can be rendered with the document to the advertisement partner. For example, a proper advertisement to display might be for car rentals if the document being viewed is a travel brochure.

Processing continues with processing block 386 which recites receiving at least one advertisement from the advertisement partner in response to the sending at least one advertisement tag associated with the document. The advertisement may be a contextual advertisement, in that the advertisement that is placed is based on the context of the document being viewed. Certain keywords are associated with the document, and are used to help determine a proper advertisement that is somewhat related to the keywords. For example, a proper advertisement to display might be for car rentals if the document being viewed is a travel brochure. The advertisements may also be dynamic advertisements in that on each viewing of the portable electronic document, the advertisement that shows up may change. This change may based on the advertisement inventory and additional viewing factors, e.g., time of day, time of year, geography in which the document is opened (example, a snowboarding advertisement would show up in the winter, a tennis advertisement in the spring).

Processing block 388 discloses rendering the at least one advertisement with the document. The advertisement can be rendered within the document content or adjacent to the document content such as in a side pane.

Processing block 390 discloses determining when an action is taken regarding the advertisement. This may include, as shown in processing block 392 tracking revenue from action being taken regarding the advertisement. For example, should a viewer of the document select (i.e., “click”) on an advertisement, the advertiser is charged for that selection. In one embodiment the advertiser is charged whatever amount the advertiser bid on the keyword or keyword phrase that caused the displaying (i.e., impression) of the advertisement. In another embodiment, each time a viewer clicks on the advertisement, the advertiser is charged for that selection. In some environments, web site owners may also receive an amount of revenue each time a viewer selects (i.e., clicks on) the advertisement that appears with the document.

Mechanisms and techniques have been described that provide the ability for authors of portable electronic documents to include dynamic, contextual advertisements with their document. The author receives payment based on how often the advertisement is clicked through. The advertisements could show up either within the portable electronic document itself or as a side pane in the document viewing experience.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method for associating advertisements with a document comprising:
identifying a document for having advertisements associated therewith, said document comprising a portable electronic document;
providing at least one advertisement tag for said document, said advertisement tag identifying possible types of advertising materials appropriate for said document; and
providing a document identifier (ID) for associating an advertisement with said document.

2. The method of claim 1 wherein said identifying a document for having advertisements associated therewith comprises setting a metadata field to indicate said document is capable of having advertisements associated therewith.

3. The method of claim 1 further comprising identifying a location for said advertisement.

4. The method of claim 3 wherein said identifying a location for said advertisement comprises one of the group consisting of identifying a location within said document for said advertisement and identifying a location adjacent to said document for said advertisement.

5. The method of claim 1 wherein said identifying a document for having advertisements associated therewith comprises identifying a Portable Document Format (PDF) document.

6. A method of rendering a document having advertisements associated therewith, the method comprising:
identifying that the document has advertisements associated therewith;
sending at least one advertisement tag associated with said document to an advertisement partner;
receiving at least one advertisement from said advertisement partner in response to said sending at least one advertisement tag associated with said document; and
rendering the at least one advertisement with said document.

7. The method of claim 6 further comprising identifying a location for said advertisement.

8. The method of claim 7 wherein said identifying a location for said advertisement comprises one of the group consisting of identifying a location within said document and identifying a location adjacent to said document.

9 The method of claim 6 further comprising determining when an action is taken regarding said advertisement.

10. A method comprising:
receiving at least one advertisement tag associated with a page-based document;
sending at least one advertisement in response to said receiving at least one advertisement tag associated with said document; and
tracking interaction with said advertisement with said document.

11. The method of claim 10 further comprising tracking revenue from interaction with said advertisement with said document.

12. A computer readable medium having computer readable code thereon for associating advertisements with a document, the medium comprising:
instructions for identifying a document for having advertisements associated therewith, said document comprising a portable electronic document;
instructions for providing at least one advertisement tag for said document, said advertisement tag identifying possible types of advertising materials appropriate for said document; and
instructions for providing a document identifier (ID) for associating an advertisement with said document.

13. The computer readable medium of claim 12 wherein said instructions for identifying a document for having advertisements associated therewith comprises instructions for setting a metadata field to indicate said document is capable of having advertisements associated therewith.

14. The computer readable medium of claim 12 further comprising instructions for identifying a location for said advertisement.

15. The computer readable medium of claim 14 wherein said instructions for identifying a location for said advertisement comprises instructions for one of the group consisting of identifying a location within said document for said ad, and identifying a location adjacent to said document for said advertisement.

16. The computer readable medium of claim 12 wherein said instructions for identifying a document for having advertisements associated therewith comprises instructions for identifying a Portable Document Format (PDF) document.

17. A computer readable medium having computer readable code thereon for rendering a document having advertisements associated therewith, the medium comprising:
instructions for identifying that the document has advertisements associated therewith;
instructions for sending at least one advertisement tag associated with said document to an advertisement partner;
instructions for receiving at least one advertisement from said advertisement partner in response to said sending at least one advertisement tag associated with said document; and
instructions for rendering the at least one advertisement with said document.

18. The computer readable medium of claim 17 further comprising instructions for identifying a location for said advertisement.

19. The computer readable medium of claim 18 wherein said instructions for identifying a location for said advertisement comprises instructions for one of the group consisting of identifying a location within said document and identifying a location adjacent to said document.

20. The computer readable medium of claim 17 further comprising instructions for determining when an action is taken regarding said advertisement.

21. A computer readable medium having computer readable code thereon for tracking revenue, the medium comprising:
instructions for receiving at least one advertisement tag associated with a page-based document;
instructions for sending at least one advertisement in response to said receiving at least one advertisement tag associated with said document; and
instructions for tracking interaction with said advertisement with said document.

22. The computer readable medium of claim 21 further comprising instructions for tracking revenue from interaction with said advertisement with said document.

23. A computer system comprising:
a memory;
a processor;
a communications interface;
an interconnection mechanism coupling the memory, the processor and the communications interface; and
wherein the memory is encoded with an application associating advertisements with a document, that when performed on the processor, provides a process for processing information, the process causing the computer system to perform the operations of:
identifying a document for having advertisements associated therewith, said document comprising a portable electronic document;
providing at least one advertisement tag for said document, said advertisement tag identifying possible types of advertising materials appropriate for said document; and
providing a document identifier (ID) for associating an advertisement with said document.

24. The computer system of claim 23 further comprising the process causing the computer system to perform the operations of:
sending the at least one advertisement tag associated with said document to an advertisement partner;
receiving at least one advertisement from said advertisement partner in response to said sending at least one advertisement tag associated with said document; and
rendering the at least one advertisement with said document.
